(19) United States
(12) Patent Application Publication
(10) Pub. No.: US 2012/0140939 A1
(43) Pub. Date: Jun. 7, 2012

(54) METHOD AND DEVICE FOR CANCELLING ACOUSTIC ECHO

(75) Inventors: In Ki HWANG, Daejeon-si (KR); Chang Y. CHOO, San Jose, CA (US); Do Young KIM, Daejeon (KR); Byung Sun LEE, Daejeon (KR)

(73) Assignee: Electronics and Telecommunications Research Institute, Daejeon (KR)

(21) Appl. No.: 13/216,444

(22) Filed: Aug. 24, 2011

Related U.S. Application Data
(60) Provisional application No. 61/420,407, filed on Dec. 7, 2010.

(30) Foreign Application Priority Data
Jun. 30, 2011 (KR) 10-2011-0064854

(51) Int. Cl. H04B 3/23

(52) U.S. Cl. 381/66

(57) ABSTRACT

An acoustic echo cancellation device for generating a pseudo echo signal by filtering an input remote speaker signal based on a plurality of adaptive filters and controlling the adaptive filters to filter the same based on a filter coefficient. The acoustic echo cancellation device generates an error signal by subtracting the pseudo echo signal from a nearby speaker signal, determines a convergence state of the filter coefficient based on the error signal, and sets at least one filter coefficient with a previously used value to stop the operation for calculating new values for the corresponding filter coefficients when the filter coefficient is determined to be converged.

### CROSS-REFERENCE TO RELATED APPLICATION

This application claims priority to and the benefit of U.S. patent Application No. 61/420,407 filed in the United States Patent and Trademark Office on Dec. 7, 2010 and Korean Patent Application No. 10-2011-0064854 filed in the Korean Intellectual Property Office on Jun. 30, 2011, the entire contents of which are incorporated herein by reference.

### BACKGROUND OF THE INVENTION

(a) Field of the Invention

The present invention relates to a device and method for cancelling an acoustic echo. More particularly, the present invention relates to a device and method for cancelling an echo that occurs when an acoustic signal is transmitted.

(b) Description of the Related Art

An acoustic echo signifies that a voice signal output by a speaker of a terminal is input to a microphone through various paths and is then transmitted to an original speaker that is a person spoke the voice signal and the acoustic echo causes confusion during a call so that methods for cancelling it have been used.

Methods for cancelling the acoustic echo use the time domain or the frequency domain, and they have been improved to satisfy the standards for reducing the echo to be less than a predetermined level, such as convergence time, long echo path performance, concurrent calling sensing time, or calculation. From among the methods, the acoustic echo cancelling method using the partitioned block frequency domain (PBFD) least mean square (LMS) method has a relatively faster convergence time and has strong performance on the long echo path compared to other algorithms. However, the method divides signals of a long path into partitioned blocks and processes the same, so it increases calculation and the terminal has difficulty in processing them in real time.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an acoustic echo cancelling device having fast performance with low power and a method thereof.

An exemplary embodiment of the present invention provides a method for cancelling an acoustic echo including: acquiring an error signal by subtracting a pseudo echo signal generated from a remote speaker signal from a nearby speaker signal; determining whether to set a low power mode based on the error signal; and when the low power mode is set, setting at least one filter coefficient used for an adaptive filter algorithm for cancelling the acoustic echo with a previously used coefficient value.

The determining includes: acquiring tendency values for indicating development of changes of the error value based on a difference value between the value of the currently acquired error signal and the value of at least one previously acquired error signal; comparing the tendency values and determining an error value has an increase tendency or an error value has a decrease tendency; when the error value is found to have a decrease tendency, comparing the value of the current error signal with at least one threshold value; and when the value of the current error signal is less than the threshold value, determining to set the low power mode.

The setting with a previously used coefficient value includes: setting a filter coefficient of a first number with a previously used value when the value of the current error signal is less than the first threshold value; setting a filter coefficient of a second number with a previously used value when the value of the current error signal is greater than the first threshold value and is less than the second threshold value; and setting a filter coefficient of a third number with a previously used value when the value of the current error signal is greater than the second threshold value and is less than the third threshold value, and it is satisfied that the first number>the second number>the third number.

Another embodiment of the present invention provides an acoustic echo cancellation method for generating a pseudo echo signal by filtering an input remote speaker signal based on a plurality of adaptive filters and controlling the adaptive filters to filter the same based on a filter coefficient, including: generating an error signal by subtracting the pseudo echo signal from a nearby speaker signal, and determining a convergence state of the filter coefficient based on the error signal; when the filter coefficient is determined to be converged, setting at least one filter coefficient with a previously used value; and when the filter coefficient is found to not be converged, the value of the filter coefficient of the adaptive filter is calculated and the corresponding filter coefficient is updated with the calculated value.

Yet another embodiment of the present invention provides a device for cancelling an acoustic echo, including: a signal sampler for sampling a remote speaker signal generated and input by a remote device and outputting N (N=a positive integer) sampling signals; an adaptive filter including M (M=a positive integer) filter modules for processing N sampling signals according to filter coefficients corresponding to the sampling signals output by the signal sampler and outputting the processed sampling signals and an addition module for adding the signals output by the M filter modules and generating a pseudo echo signal; an error signal generator for generating an error signal by subtracting the pseudo echo signal from a nearby speaker signal; and a filter controller for determining the convergence state of the filter coefficient based on the error signal, and setting at least one filter coefficient used by the filter module of the adaptive filter with a previously used value when filter coefficient is found to be converged.

### BRIEF DESCRIPTION OF THE DRAWINGS

FIG. 1 shows a configuration diagram of an acoustic cancelling device according to an exemplary embodiment of the present invention.

FIG. 2 shows a process for an acoustic echo cancelling device according to an exemplary embodiment of the present invention to generate an error signal.

FIG. 3 shows a configuration of an FFT operator according to an exemplary embodiment of the present invention.

FIG. 4 shows a flowchart of an acoustic echo cancelling method according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

An acoustic echo cancelling device and method thereof according to an exemplary embodiment of the present invention will now be described with reference to accompanying drawings.

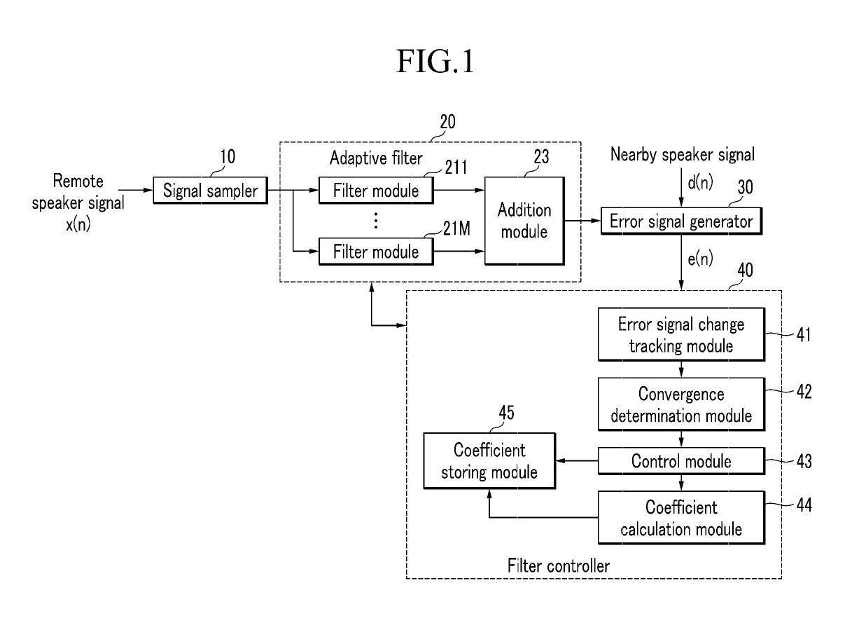

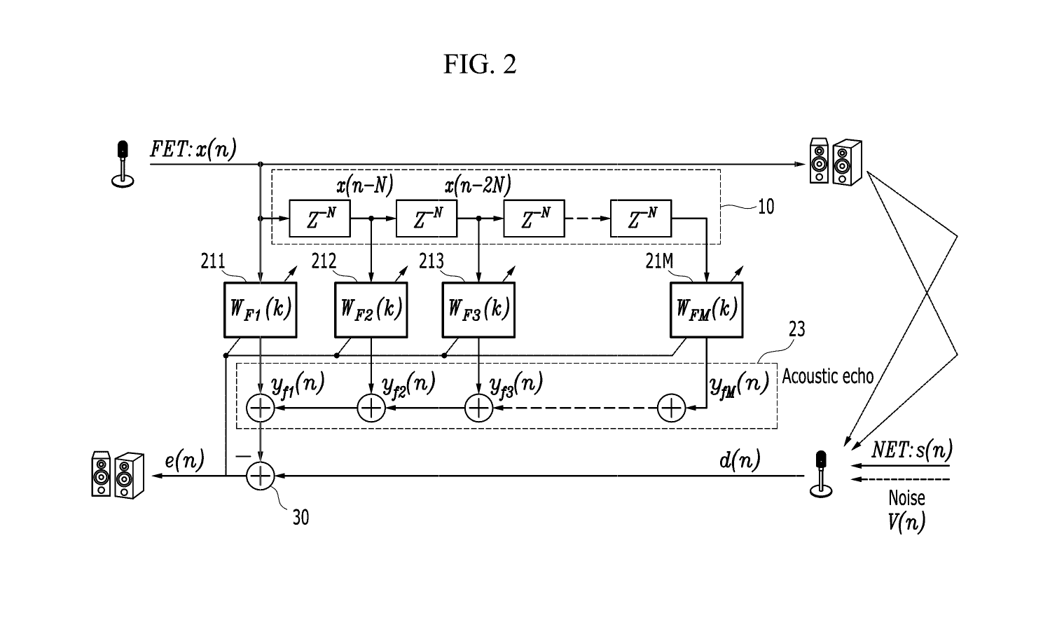

FIG. 1 shows a configuration diagram of an acoustic cancelling device according to an exemplary embodiment of the present invention, and FIG. 2 shows a process for an acoustic echo cancelling device according to an exemplary embodiment of the present invention to generate an error signal.

As shown in FIG. 1, the acoustic echo cancel device 1 includes a signal sampler 10, an adaptive filter 20, an error signal generator 30, and a filter controller 40.

The signal sampler 10 samples a signal (hereinafter, a remote speaker signal) generated and input by a remote device and outputs a sampled signal. For example, the signal sampler 10 samples the remote speaker signal (x(n)) to output N sampling signals as shown in FIG. 2.

The adaptive filter 20 generates a pseudo echo signal by processing the sampled remote speaker signal output by the signal sampler 10. In detail, the adaptive filter 20 includes M filter modules (211, 212, . . . , 21M) for processing and outputting sampling signals according to a filter coefficient in correspondence to N sampling signals, and an addition module 23 for summing the signals output by the M filter modules and generating a pseudo echo signal (y_{fM}(n)). The adaptive filter 20 generates an acoustic echo that is a pseudo echo signal for the entire N×M signals.

The error signal generator 30 generates an echo signal, that is, an error signal, by subtracting a pseudo echo signal from a nearby speaker signal (d(n)) as shown in FIG. 2.

The filter controller 40 updates a filter coefficient of the adaptive filter 20, and particularly, the filter controller 40 determines whether to update the filter coefficient based on a current error signal generated and input by the error signal generator 30 and a previous error signal. For this purpose, the filter controller 40 includes an error signal change tracking module 41 for determining development of changes of the error signal based on the current error signal and the previous error signals, a convergence determination module 42 for determining a convergence state of the adaptive filter coefficient based on the development of changes of the error signal, a coefficient calculation module 44 for calculating an adaptive filter coefficient, and a control module 43 for selectively operating the coefficient calculation module 44 according to the convergence state determination result. It further includes a coefficient storing module 45 for storing a filter coefficient of the adaptive filter. The coefficient storing module 45 stores values calculated by the coefficient calculation module 44 for respective filter coefficients or a value (e.g., a previously calculated value) set by the control module 43. A detailed operation of the filter controller 40 will be described later.

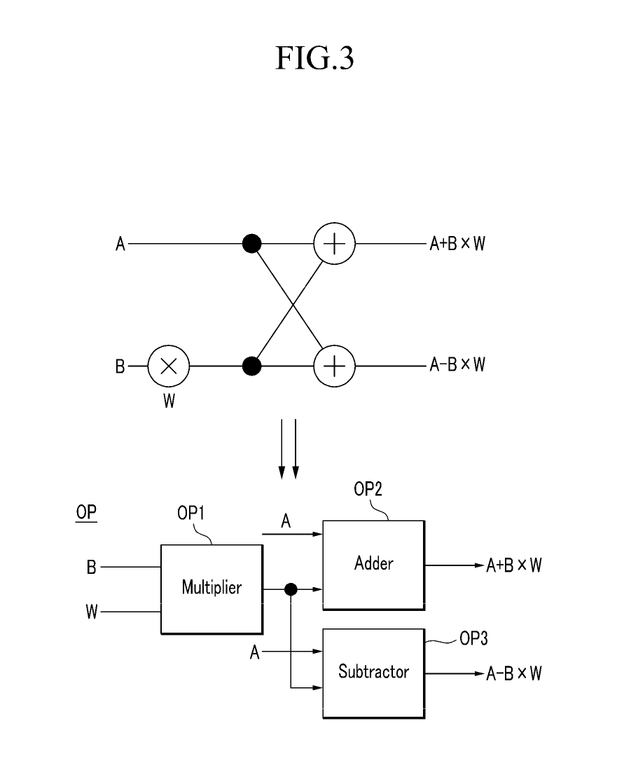

The filter modules (211, 212, . . . , 21M) include an FFT operator for processing the signals sampled according to the adaptive filter algorithm. FIG. 3 shows a configuration of an FFT operator according to an exemplary embodiment of the present invention. The FFT shown in FIG. 3 exemplifies a radix-2 FFT in the butterfly structure. In general, such radix-2 FFT operator performs a complex number multiplication including real number multiplication 4 times and real number addition twice.

The FFT operator (OP) in the butterfly structure according to an exemplary embodiment of the present invention includes a multiplier OP1, an adder OP2, and a subtractor OP3 as shown in FIG. 3.

The multiplier OP1 multiplies the input signal B and the filter coefficient W and outputs a predetermined signal, and the adder OP2 adds the input signal A and the output signal provided by the multiplier OP1. The subtractor OP3 subtracts the input signal provided by the multiplier OP1 from the input signal A and outputs a predetermined signal. Therefore, the signal output by the adder OP2 is A+B×W, and the signal output by the subtractor OP3 is A−B×W. Here, the filter coefficient W is a twiddle factor, and the operation of the FFT operator (OP) with such configuration is known to a person skilled in the art and no detailed description thereof will be provided.

The exemplary embodiment of the present invention uses the method for cancelling the acoustic echo by using the partitioned block frequency domain (PBFD) least mean square (LMS) method (hereinafter, PBFD-LMS method). The PBFD-LMS method outperforms the existing time domain least mean square (TD-LMS) method regarding the signal about a long echo path because, for example, it uses ⅙ time until reaching the +30 dB error return loss enhancement (ERLE) and it tracks the acoustic echo for the (N×M) samples. The exemplary embodiment of the present invention selectively updates the filter coefficient for the adaptive filter in order to cancel the acoustic echo with faster processing rates and low power while using the PBFD-LMS method.

The acoustic echo cancel device according to an exemplary embodiment of the present invention may be realized to be in an embedded system, and is not restricted thereto.

An acoustic echo cancelling method according to an exemplary embodiment of the present invention will now be described based on the above-described device.

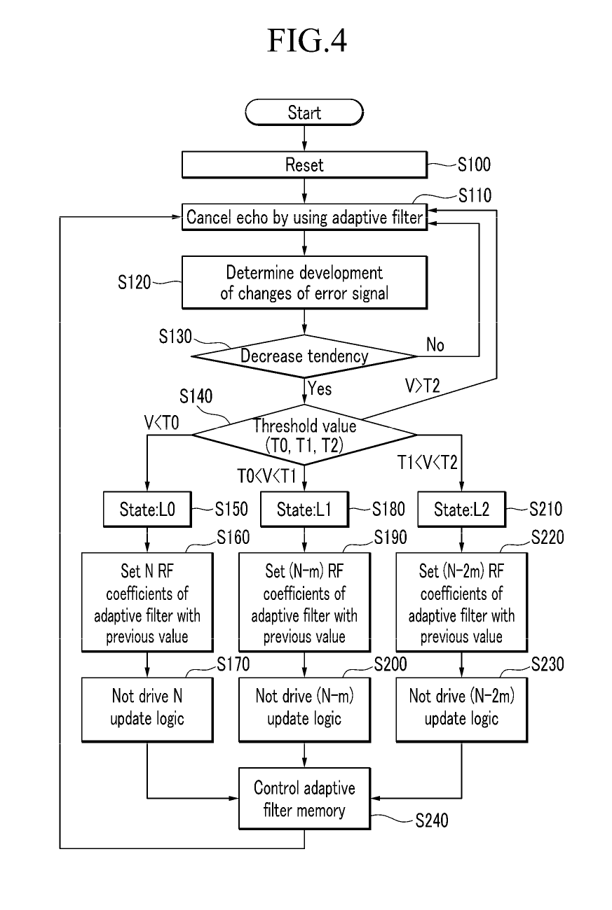

FIG. 4 shows a flowchart of an acoustic echo cancelling method according to an exemplary embodiment of the present invention.

A remote speaker signal x(n) generated by a remote device is input to an acoustic echo cancel device 1 to be sampled and is then processed by the adaptive filter 20, and the adaptive filter 20 processes the sampled remote speaker signal based on a predetermined adaptive filter coefficient (hereinafter, a filter coefficient) to generate a pseudo echo signal. A method for processing the sampled remote speaker signal based on the filter coefficient using adaptive algorithm, particularly the PBFD-LMS algorithm, is known to a skilled person, so a detailed description thereof will be omitted.

The pseudo echo signal generated by the adaptive filter 20 is input to the error signal generator 30, and the error signal generator 30 subtracts the pseudo echo signal from the nearby speaker signal to output an error signal (S100 and S110).

The error signal change tracking module 41 of the filter controller 40 determines development of changes of the error signal based on a plurality of previously acquired error signals and a currently input error signal (hereinafter, a current error signal) that is processed and currently input by the error signal generator 30 (S120). That is, it determines the development of changes based on the L previous error signals and the current error signal being input. When the value of the previous error signal is subtracted from the value of the current error signal, the instant change of the error signal is known, so it calculates difference values for the L previous error signals and calculates a tendency value for expressing development of changes for the error signal based on the difference values. It determines the development of changes of the error signal based on the calculated tendency value, and particularly it determines the development of changes of the error signal by checking the change between the tendency values.

The current error signal is set to be E(L) and the L previous signals are set to be E(L-1), E(L-2), . . . . , E(L-(L-1)), E(L-L). The difference values can be expressed to be an absolute value of the difference value between one error signal and its previous error signal, that is, E′(L)=|E(L)|−|(L-1)|, E′(L-1)=|E (L-1)|−|E(L-2)|. Regarding the calculated difference values, the difference between one difference value and its previous difference value is found and is used as a tendency value. That is, the tendency value is defined to be E″(L)=E′(L)−E′(L-1). Based on it, a plurality of tendency values (E″(L)=E′(L)−E′(L-1), E″(L-1)=E′(L-1)−E′(L-2), . . . . , E″(L-L)=E′(L-L)−E′(L-(L-1)) for a plurality of difference values are acquired.

The decrease or increase tendency for the error signal is determined by comparing the acquired tendency values and the previous tendency values (S130).

One tendency value E″(L) and its previous tendency value E″(L-1) are compared, and when the E″(L) is found to be equal to E″(L-1), the current error signal value is determined to be reduced. Particularly, the error value of the error signal is determined to be reduced with the same tendency.

On the other hand, when one tendency value is less than its previous tendency value, that is, E″(L)<E″(L-1), it is determined that the error signal value has a tendency to decrease and that the decrease tendency is becoming low. In the exemplary embodiment of the present invention, the error signal value has a decrease tendency, and when the decrease tendency is determined to be low, the current error signal value is compared with predetermined threshold values to determine a convergence state of the filter coefficient.

Further, when it is given that E″(L)>E″(L-1), the error signal value is determined to have a tendency to increase, and the development of changes of the error signal values are tracked as described above until the error signal decreasing tendency according to an exemplary embodiment of the present invention becomes low.

When the error signal decreasing tendency is determined to be low, that is, when the current tendency value is compared to and found to be less than or equal to the previous tendency value, an error value of the current error signal is compared with predetermined threshold values, and in the exemplary embodiment of the present invention, three threshold values T0, T1, and T2 are compared with the error value (S140). For ease of convenience, T0 will be called a first threshold value, T1 a second threshold value, and T2 a third threshold value, and the threshold values satisfy the relationship of T0<T1<T2.

In the exemplary embodiment of the present invention, when the error value of the current signal is less than the threshold values, the filter coefficient value is already converged, and in the convergence state, the acoustic echo cancel device 1 is operable in a low power mode some filter coefficients are not operated, which will be described later. When the value of the adaptive filter coefficient is already converged, the change of the value is not substantially changed, and the signal of the high frequency band is changed relatively less than the signal of the low frequency band in which much energy of voice signals is gathered. Therefore, the filter coefficient operation for the signals of the high frequency band that is greater than a predetermined band is bypassed based on the convergence state.

Particularly, in the exemplary embodiment of the present invention, the state in which the filter coefficient value is converged is classified into first to third states depending on the relationship between the error value and the threshold values and the number of filter coefficients bypassing the operation for respective convergence states.

The control module 43 of the filter controller 40 maintains the N filter coefficients for the adaptive filter 20 to process the signals of the high frequency equency band at previous values (S160) in the case of the first state (L0) (S150) in which the error value of the current error signal is less than the first threshold value T0 while the filter coefficient is converged. The control module 43 controls the coefficient calculation module 44 to not perform update logic for calculating a new value for the N filter coefficients, and thereby does not perform the operation for calculating the filter coefficient for the signals of the high frequency band (S170).

In addition, when the error value of the current error signal is greater than the first threshold value T0 and is less than the second threshold value T1 (i.e., a second state L1) (S180), the control module 43 maintains the (N-m) filter coefficients for the adaptive filter 20 to process the signal of the high frequency band at the previous values (S190). The control module 43 controls the coefficient calculation module 44 to not perform update logic for the (N-m) filter coefficients to calculate new values, and thereby does not perform an operation for calculating the filter coefficient for the signal of the high frequency band S200).

When the error value of the current error signal is greater than the second threshold value T1 and is less than the third threshold value T2 (i.e., a third state L2) (S210), the control module 43 maintains the (N-2m) filter coefficients for the adaptive filter 20 to process the signal of the high frequency band at the previous values (S220). The control module 43 controls the coefficient calculation module 44 to not perform update logic for calculating new values for the (N-2m) filter coefficients and thereby does not perform an operation for calculating the filter coefficient for the signal fo the high frequency band (S230).

Accordingly, when the error value of the current error signal is less than the first threshold value (i.e., a first state L0), it is determined that the filter coefficient value is not substantially changed and the signal of the high frequency band is relatively less changed, so an operation for the filter coefficients that are more than the other states L1 and L2 are bypassed and the previous values for the corresponding filter coefficients are used. The number of filter coefficients of which their operation is bypassed in the second state L1 is greater than the number of filter coefficients of which their operation is bypassed in the third state L2.

The control module 43 of the filter controller 40 stores the values of the filter coefficients for processing a predetermined number of the high frequency band signals to be used to process the current adaptive filter in an adaptive filter memory for storing the coefficients for controlling the adaptive filter 20, that is, a coefficient storing module 45, as previously calculated values so that a predetermined number of filter coefficients may maintain the previous values (S240).

When the filter coefficient is determined to have been converged through the above-described process, the values of fillter coefficients for the predetermined number of the high frequency band signals can be maintained at the previous values, and the operation for the filter coefficients for the high frequency band is not performed as a result, so the process for performing the operation is omitted to improve the speed for processing cancellation of the echo signal and reduce power consumption generated during the process.

The filter coefficient W used for the adaptive filter 20 can be found from the subsequent equation.

W=W_{old}+X×E×μ [Equation 1]

Here, W_{old} is a previous filter coefficient value, and X is a remote speaker signal, particularly, a fast Fourier transformed (FFTed) remote speaker signal. E is an error signal, particularly an FFTed error signal. μ is a step size coefficient of an adaptive filter. Here, W, X, and E are matrix values of the frequency domain, having the size of (sample count)×(block count), that is, N×M. Therefore, when the previous values are used for the N filter coefficients in the first state, the operational time used to calculate the filter coefficient is saved since the addition operation for calculating the filter coefficient is not performed by the number of N×(block count) and the multiplication operation is not performed by the number of {N×(block count)}² according to Equation 1. Also, power consumption can be reduced since the adder and the multiplier are not operated.

In the low power mode in which the development of changes of the error value is in the decrease tendency, the filter coefficient is determined to be converged based on the error value of the current error signal and the operation for the filter coefficients is bypassed, and when the development of changes of the value of the error signal is observed as described above to determine that the error signal value has the increasing tendency (e.g., when the current tendency value is greater than the previous tendency value), or when the value of the current error signal is greater than the threshold values during the decrease tendency, the low power mode is restored to the normal operational mode to newly calculate the filter coefficients of the adaptive filter 20 for cancelling the echo signal and perform an update process using the calculated values.

According to the exemplary embodiment of the present invention, when the adaptive filter algorithm is used to cancel the acoustic echo and the filter coefficient is determined to be converged, values of a predetermined number of filter coefficients are maintained at the previous values to omit the process for updating the filter coefficient, improve the speed for cancelling the echo signal, and thereby reduce power consumption for the process.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

what is claimed is:

1. A method for cancelling an acoustic echo comprising:
acquiring an error signal by subtracting a pseudo echo signal generated from a remote speaker signal from a nearby speaker signal;
determining whether to set a low power mode based on the error signal; and
when the low power mode is set, setting at least one filter coefficient used for an adaptive filter algorithm for cancelling the acoustic echo with a previously used coefficient value.

2. The method of claim 1, wherein
the determining determines whether to set the low power mode based on a value of a current error signal and development of changes of an error value based on values of error signals.

3. The method of claim 2, wherein
the determining includes:
acquiring tendency values for indicating development of changes of the error value based on a difference value between the value of the currently acquired error signal and the value of the at least one previously acquired error signal;
comparing the tendency values and determining an error value increase tendency or an error value decrease tendency;
when the error value is found to have a decrease tendency, comparing the value of the current error signal with at least one threshold value; and
when the value of the current error signal is less than the threshold value, determining to set the low power mode.

4. The method of claim 3, wherein
the acquiring of a tendency value uses a difference between one difference value and a previous difference value for the tendency value.

5. The method of claim 4, wherein when the current error signal is E(L) and L previous error signals (E(L-1), E(L-2), . . . , E(0)) are used, the one difference value E′(L) and the previous difference value E′(L-1) satisfy the subsequent conditions, and the tendency value E″(L) satisfies the next conditions:
E′(L)=|E(L)|−|E(L-1)|,
E′(L-1)=|E(L-1)|−|E(L-2)|, and
E″(L)=E′(L)−E′(L-1).

6. The method of claim 5, wherein
the determining of a tendency compares one tendency value E″(L) and its previous tendency value E″(L-1)=E′(L-1)−E′(L-2), and when E″(L) is found to be less than or equal to E″(L-1), determins that the error value has a decrease tendency.

7. The method of claim 3, wherein
the comparing with a threshold value includes comparing a value of a current error signal with first to third threshold values, and
the determining whether to set the low power mode includes setting the low power mode when the value of the current error signal is less than the first to third threshold values.

8. The method of claim 7, wherein
the first threshold value<the second threshold value<the third threshold value is satisfied.

9. The method of claim 8, wherein
the setting with a previously used coefficient value includes:
setting a filter coefficient of a first number with a previously used value when the value of the current error signal is less than the first threshold value;
setting a filter coefficient of a second number with a previously used value when the value of the current error signal is greater than the first threshold value and is less than the second threshold value; and
setting a filter coefficient of a third number with a previously used value when the value of the current error signal is greater than the second threshold value and is less than the third threshold value, and
the first number>the second number>the third number is satisfied.

10. The method of claim 1, wherein
the setting with a previously used coefficient value includes
setting a filter coefficient for a signal of high frequency band that is greater than a predetermined band with the previously used coefficient value.

11. An acoustic echo cancellation method for generating a pseudo echo signal by filtering an input remote speaker signal based on a plurality of adaptive filters and controlling the adaptive filters to filter the same based on a filter coefficient, comprising:
generating an error signal by subtracting the pseudo echo signal from a nearby speaker signal, and determining a convergence state of the filter coefficient based on the error signal;
when the filter coefficient is determined to be converged, setting at least one filter coefficient with a previously used value; and
when the filter coefficient is found to not be converged, the value of the filter coefficient of the adaptive filter is calculated and the corresponding filter coefficient is updated with the calculated value.

12. The method of claim 11, wherein
the determining of a convergence state includes
determining that the filter coefficient is converged when the error value is determined to have a decrease tendency based on the difference value between the value of the currently acquired error signal and the value of at least one previously acquired error signal, and the value of the current error signal is less than a predetermined threshold value.

13. The method of claim 12, wherein
the determining of a convergence state includes comparing the value of the current error signal and first to third threshold values and determining that the filter coefficient is converged when the value of the current error signal is less than the first to third threshold values, and
the setting of at least one filter coefficient with a previously used coefficient value includes:
setting the first numbered filter coefficients with the previously used value when the value of the current error signal is less than the first threshold value;
setting the second numbered filter coefficients with the previously used value when the value of the current error signal is greater than the first threshold value and less than the second threshold value; and
setting the third numbered filter coefficient with the previously used value when the value of the current error signal is greater than the second threshold value and less than the third threshold value, and
the relationship that the first number>the second number>the third number is satisfied.

14. The method of claim 11, wherein
the setting with the previously used value includes
setting the filter coefficient for the signal of high frequency band that is greater than a predetermined band with the previously used coefficient value.

15. The method of claim 11, wherein
the adaptive filter uses the partitioned block frequency domain (PBFD) least mean square (LMS) method.

16. A device for cancelling an acoustic echo, comprising:
a signal sampler for sampling a remote speaker signal generated and input by a remote device and outputting N (N=a positive integer) sampling signals;
an adaptive filter including M (M=a positive integer) filter modules for processing N sampling signals according to filter coefficients corresponding to the sampling signals output by the signal sampler and outputting the processed sampling signals, and an addition module for adding the signals output by the M filter modules and generating a pseudo echo signal;
an error signal generator for generating an error signal by subtracting the pseudo echo signal from a nearby speaker signal; and
a filter controller for determining the convergence state of the filter coefficient based on the error signal, and setting at least one filter coefficient used by the filter module of the adaptive filter with a previously used value when the filter coefficient is found to be converged.

17. The device of claim 16, wherein
the filter controller includes:
a coefficient calculation module for calculating a filter coefficient of the adaptive filter;
a coefficient storing module for storing values of the filter coefficients of the adaptive filter;
an error signal change tracking module for determining development of changes of an error signal based on a current error signal and previous error signals;
a convergence determining module for comparing the value of the current error signal and a predetermined threshold value and determining a convergence state of the adaptive filter coefficient when the error signal has the decrease tendency according to the result of determining the development of changes; and
a control module for setting at least one the first filter coefficient used by the filter module of the adaptive filter of the adaptive filter with the previously used value when the filter coefficient is converged, and calculating other filter coefficients except the first filter coefficient by operating the coefficient calculation module.

18. The device of claim 16, wherein
the first filter coefficient is a filter coefficient for a signal of high frequency band that is greater than a predetermined band.

19. The device of claim 16, wherein
the control module
sets the first numbered first filter coefficient with a previously used value when the value the current error signal is less than the first threshold value,
sets the second numbered first filter coefficient with a previously used value when the value of the current error signal is greater than the first threshold value and less than the second threshold value, and
sets the third numbered first filter coefficient with a previously used value when the value of the current error signal is greater than the second threshold value and less than the third threshold value.

20. The device of claim 16, wherein
the filter module performs filtering based on the partitioned block frequency domain (PBFD) least mean square (LMS) method.
